(19) United States
(12) Patent Application Publication
(10) Pub. No.: US 2002/0002559 A1
(43) Pub. Date: Jan. 3, 2002

(54) Method and system for automated inference of physico-chemical interaction knowledge via co-occurrence analysis of indexed literature databases

(76) Inventor: William B. Busa, Renfrew, PA (US)

Correspondence Address: McDonnell Boehnen Hulbert & Berghoff, 32nd Floor, 300 S. Wacker Srive, Chicago, IL, 60606, US

(21) Appl. No.: 09/769,169

(22) Filed: Jan. 24, 2001

Related U.S. Application Data
(60) Provisional application No. 60/177,964, filed on Jan. 25, 2000.

(51) Int. Cl. G06F 17/30

(52) U.S. Cl. 707/104.1; 707/3; 707/102

(57) ABSTRACT

A method and system for automated inference of physico-chemical interaction via co-occurrence analysis of indexed databases. One or more inferences between chemical or biological molecules are automatically generated using a connection network. The methods and system described herein may allow scientists and researchers to automatically create and check inferences of physico-chemical interactions of chemical or biological molecules via co-occurrence analysis of indexed databases. The present invention may also be used to further facilitate a user's understanding of biological functions, such as cell functions, to design experiments more intelligently and to analyze experimental results more thoroughly by automatically creating physico-chemical inferences with co-occurrences. Specifically, the present invention may help drug discovery scientists select better targets for pharmaceutical intervention in the hope of curing diseases. The method and system may also help facilitate the abstraction of knowledge from information for biological experimental data and provide new bioinformatic techniques.

### CROSS REFERENCES TO RELATED APPLICATIONS

This application claims priority from U.S. Provisional Application No. 60/177,964, filed on Jan. 25, 2000.

### FIELD OF THE INVENTION

This invention relates to analyzing experimental information. More specifically, it relates to a method and system for creating automated inferences of physico-chemical interactions via co-occurrence analysis of indexed scientific literature databases.

### BACKGROUND OF THE INVENTION

Traditionally, cell biology research has largely been a manual, labor intensive activity. With the advent of tools that can automate much cell biology experimentation (see for example, U.S. Pat. Nos. 5,989,835 and 6,103,479), the rate at which complex information is generated about the functioning of cells has increased dramatically. As a result, cell biology is not only an academic discipline, but also the new frontier for large-scale drug discovery.

Cells are the basic units of life and integrate information from Deoxyribonucleic Acid (“DNA”), Ribonucleic Acid (“RNA”), proteins, metabolites, ions and other cellular components. New compounds that may look promising at a nucleotide level may be toxic at a cellular level. Florescence-based reagents can be applied to cells to determine ion concentrations, membrane potentials, enzyme activities, gene expression, as well as the presence of metabolites, proteins, lipids, carbohydrates, and other cellular components.

Innovations in automated screening systems for biological and other research are capable of generating enormous amounts of data. The massive volumes of data being generated by these systems and the effective management and use of information from the data has created a number of very challenging problems.

To fully exploit the potential of data from high-volume data generating screening instrumentation, there is a need for new informatic and bioinformatic tools. As is known in the art, “bioinformatic” techniques are used to address problems related to the collection, processing, storage, retrieval and analysis of biological information including cellular information. Bioinformatics is defined as the systematic development and application of information technologies and data processing techniques for collecting, analyzing and displaying data obtained by experiments, modeling, database searching, and instrumentation to make observations about biological processes.

Recent advances in the automation of molecular and cellular biology research including High Content and High Throughput Screening (“HCS” and “HTS,” respectively), automated genome sequencing, gene expression profiling via complementary DNA (“cDNA”) microarray and bio-chip technologies, and protein expression profiling via mass spectrometry and others are producing unprecedented quantities of data regarding the chemical constituents (i.e., proteins, nucleic acids, and small molecules) of cells relevant to health and disease.

There are several problems associated with analyzing chemical constituent data generated by automated screening systems. One problem is that there is a major bottleneck in the analysis and application of such data. Tasks such as pharmaceutical research typically require knowledgeable experts (i.e., molecular and cellular biologists) to place such data within a “biological context.” For example, given a gene expression profile indicating that expression of Gene X is inhibited in cells treated with Compound Y, this datum becomes significant for the drug discovery process only upon inspection by a cell biologist who is able to reason: “I know that the protein coded for by Gene X affects Protein Z, the over-activity of which underlies disease A. Therefore, these data indicate that Compound Y may prove useful as a drug for the treatment of disease A.” Such reasoning is also called an “inference.”

Such reasoning requires detailed knowledge of the sequences of physico-chemical interactions between molecules in cells (i.e., the cell biologist must know that the protein encoded by Gene X affects Protein Z). Such “manual” assessment of data's significance is becoming more and more unworkable as the rate of data production continues to increase.

Another problem is that analysis of biological data in light of molecular interactions is not easy to automate. Given a suitable electronic database of known physico-chemical interactions between molecules in cells, much of this manual inspection and reasoning could be automated, increasing the efficiency of tasks such as drug discovery and genetic analysis. However as currently practiced in the art, constructing such a database would be an “expert systems engineering” task, requiring domain experts to enter into the database their explicit and implicit knowledge regarding known interactions between biological molecules.

As is known in the art, an “expert system” is an application program that makes decisions or solves problems in a particular field, such as biology or medicine, by using knowledge and analytical rules defined by experts in the field. An expert system typically uses two components, a knowledge base and an inference engine, to automatically form conclusions. Additional tools include user interfaces and explanation facilities, which enable the system to justify or explain its conclusions. “Manual expert system engineering” includes manually applying knowledge and analytical rules defined by experts in the field to form conclusions or inferences. Typically, such conclusions are then manually added to a knowledge base for a particular field (e.g., biology).

In the human genome alone there are approximately 100,000 genes, encoding a like number of proteins (i.e., each of which may occur in several distinct forms due to splice variants and covalent modifications). In addition there are a large but unknown number (e.g., thousands to tens of thousands) of different small organic molecules whose interactions with each other and with proteins and nucleic acids should also be represented in a comprehensive physico-chemical interaction database. It is very difficult to determine with any degree of certainty the total number of such interactions, or even the number of currently known interactions. However the combinatorial problem presented by numbers of this magnitude prevents development of truly comprehensive and up-to-date biomolecule interaction databases when their construction is approached as an expert system engineering task based on direct input of knowledge by experts. As is known in the art, a “combinatorial problem” is a problem related to probability and statistics, involving the study of counting, grouping, and arrangement of finite sets of elements.

There have been attempts to create databases including biomolecule interactions with inferences via the manual “expert systems engineering” approach. However, such expert systems currently elect to severely restrict the scope of their coverage (e.g., to a few tens or hundreds of “key” proteins, or to the biomolecules of only the simplest organisms, such as bacteria and fungi, whose relatively small genomes encode many fewer proteins than does the human genome). In addition such manual expert systems typically make little, if any, effort to incorporate new information in a timely fashion.

Such expert system engineering approaches include, for example: (1) Pangea Systems Inc.'s (1999 Harrison Street, Suite 1100, Oakland, Calif. 94612) “EcoCyc database.” (www.pangeasystems.com). Information on this database and the other databases can be found on the Internet at the Universal Resource Locators (“URL”) indicated. This database's coverage in general includes basic metabolic pathways of the bacterium, E. coli; (2) Proteome Inc.'s (100 Cummings Center, Suite 435M, Beverly, Mass. 01915) “Bioknowledge Library” (www.proteome.com). This is a suite of databases of curated information including in general sequenced genes of the yeast, S. cerevisiae, and the worm, C. elegans. A number of well-established protein-protein interactions are included; and (3) American Association for the Advancement of Science's (1200 New York Ave. NW, Washington, DC 20005) “Science's Signal Transduction Knowledge Environment” (www.stke.org). This connections map database seeks to document some of the best-established biomolecular interactions in a select number of signal transduction pathways.

However, such selected databases and others known in the art, take a manual “expert system engineering” approach or semi-automated approaches to populating the databases (e.g., human authorities manually input into a database their individual understandings of the details of what is known regarding individual biomolecular interactions.)

Thus, it is desirable to automatically populate biomolecular interaction databases including inferences without manual expert systems engineering or manual inputs. Such an approach should help solve the combinatorial data analysis problem for biomolecular interactions and permit the construction of comprehensive databases of knowledge concerning biomolecular interactions.

### SUMMARY OF THE INVENTION

In accordance with preferred embodiments of the present invention, some of the problems associated with populating biomolecular interaction databases are overcome. A method and system for automated inference of chemical or biological molecular physico-chemical interactions via co-occurrence analysis of indexed scientific literature databases is presented.

One aspect of the invention includes a method for creating automated inferences. One or more inferences regarding expert knowledge of interactions between chemical or biological molecules are automatically generated using a connection network.

Another aspect of the invention includes a method for checking automatically created inferences. The method includes automatically deleting data determined to include trivial association inferences from an inference database, thereby improving the inference knowledge stored in the inference database.

The methods and system described herein allows scientists and researchers to automatically create and check inferences of physico-chemical interactions via co-occurrence analysis of indexed databases. The method and system may also be used to further facilitate a user's understanding of biological functions, such as cell functions, to design experiments more intelligently and to analyze experimental results more thoroughly. Specifically, the present invention may help drug discovery scientists select better targets for pharmaceutical intervention in the hope of curing diseases.

The foregoing and other features and advantages of preferred embodiments of the present invention will be more readily apparent from the following detailed description. The detailed description proceeds with references to the accompanying drawings.

### BRIEF DESCRIPTION OF THE DRAWINGS

Preferred embodiments of the present invention are described with reference to the following drawings, wherein:

FIG. 1 illustrates an exemplary experimental data storage system for storing experimental data;

FIGS. 2A and 2B are a flow diagram illustrating a method for creating automated inferences;

FIG. 3 is block diagram visually illustrating the method of FIGS. 2A and 2B; and

FIG. 4 is a flow diagram illustrating a method for checking automatically created inferences.

### DETAILED DESCRIPTION OF PREFERRED EMBODIMENTS

Exemplary Data Storage System

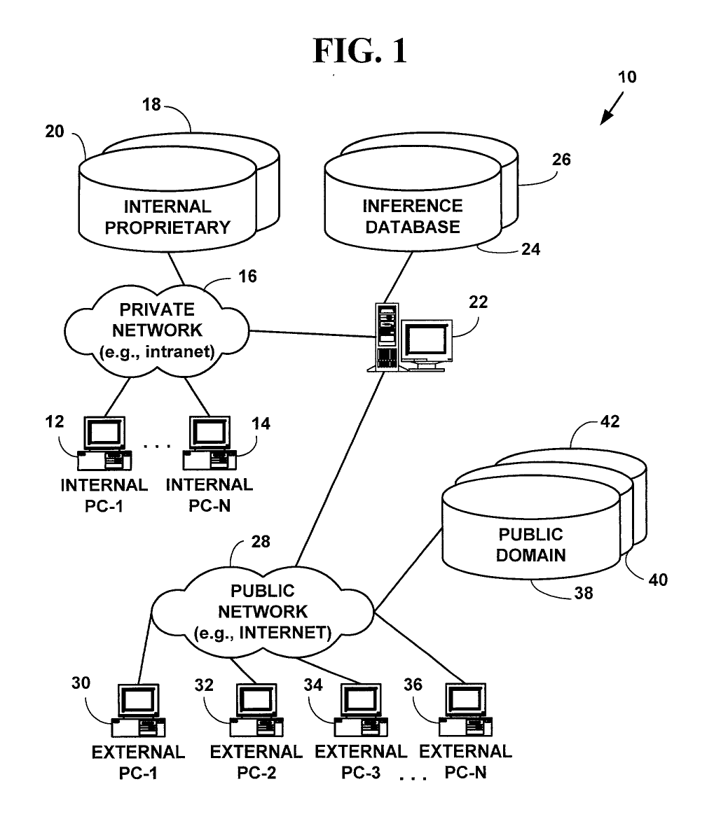

FIG. 1 illustrates an exemplary experimental data storage system 10 for one embodiment of the present invention. The data storage system 10 includes one or more internal user computers 12, 14, (only two of which are illustrated) for inputting, retrieving and analyzing experimental data on a private local area network (“LAN”) 16 (e.g., an intranet). The LAN 16 is connected to one or more internal proprietary databases 18, 20 (only two of which are illustrated) used to store private proprietary experimental information that is not available to the public.

The LAN 16 is connected to an publicly accessible database server 22 that is connected to one or more internal inference databases 24, 26 (only two of which are illustrated) comprising a publicly available part of a data store for inference information. The publicly accessible database server 22 is connected to a public network 28 (e.g., the Internet). One or more external user computers, 30, 32, 34, 36 (only four of which are illustrated) are connected to the public network 28, to plural public domain databases 38, 40, 42 (only three of which are illustrated) and one or more databases 24, 26 including experimental data and other related experimental information available to the public. However, more, fewer or other equivalent data store components can also be used and the present invention is not limited to the data storage system 10 components illustrated in FIG. 1.

In one specific exemplary embodiment of the present invention, data storage system 10 includes the following specific components. However, the present invention is not limited to these specific components and other similar or equivalent components may also be used. The one or more internal user computers, 12, 14, and the one or more external user computers, 30, 32, 34, 36, are conventional personal computers that include a display application that provide a Graphical User Interface (“GUI”) application. The GUI application is used to lead a scientist or lab technician through input, retrieval and analysis of experimental data and supports custom viewing capabilities. The GUI application also supports data exported into standard desktop tools such as spreadsheets, graphics packages, and word processors.

The internal user computers 12, 14, connect to the one or more private proprietary databases 18, 20, the publicly accessible database server 22 and the one or more or more public databases 24, 26 over the LAN 16. In one embodiment of the present invention, the LAN 16 is a 100 Mega-bit (“Mbit”) per second or faster Ethernet, LAN. However, other types of LANs could also be used (e.g., optical or coaxial cable networks). In addition, the present invention is not limited to these specific components and other similar components may also be used.

In one specific embodiment of the present invention, one or more protocols from the Internet Suite of protocols are used so LAN 16 comprises a private intranet. Such a private intranet can communicate with other public or private networks using protocols from the Internet Suite. As is known in the art, the Internet Suite of protocols includes such protocols as the Internet Protocol (“IP”), Transmission Control Protocol (“TCP”), User Datagram Protocol (“UDP”), Hypertext Transfer Protocol (“HTTP”), Hypertext Markup Language (“HTML”), eXtensible Markup Language (“XML”) and others.

The one or more private proprietary databases 18, 20, and the one or more publicly available databases 24, 26 are multi-user, multi-view databases that store experimental data. The databases 18, 20, 24, 26 use relational database tools and structures. The data stored within the one or more internal proprietary databases 18, 20 is not available to the public. Databases 24, 26, are made available to the public through publicly accessable database server 22 using selected security features (e.g., login, password, encryption, firewall, etc.)

The one or more external user computers, 30, 32, 34, 36, are connected to the public network 28 and to plural public domain databases 38, 40, 42. The plural public domain databases 38, 40, 42 include experimental data and other information in the public domain and are also multi-user, multi-view databases. The plural public domain databases 38, 40, 42, include such well known public databases such as those provided by Medline, GenBank, SwissProt, described below and other known public databases.

An operating environment for components of the data storage system 10 for preferred embodiments of the present invention include a processing system with one or more high speed Central Processing Unit(s) (“CPU”) or other processor(s) and a memory system. In accordance with the practices of persons skilled in the art of computer programming, the present invention is described below with reference to acts and symbolic representations of operations or instructions that are performed by the processing system, unless indicated otherwise. Such acts and operations or instructions are referred to as being “computer-executed,” “CPU executed,” or “processor executed.”

It will be appreciated that acts and symbolically represented operations or instructions include the manipulation of electrical signals by the CPU. An electrical system represents data bits which cause a resulting transformation or reduction of the electrical signals, and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to the data bits.

The data bits may also be maintained on a computer readable medium including magnetic disks, optical disks, organic memory, and any other volatile (e.g., Random Access Memory (“RAM”)) or non-volatile (e.g., Read-Only Memory (“ROM”)) mass storage system readable by the CPU. The computer readable medium includes cooperating or interconnected computer readable medium, which exist exclusively on the processing system or may be distributed among multiple interconnected cooperating processing systems that may be local or remote to the processing system.

Creating Inferences Automatically

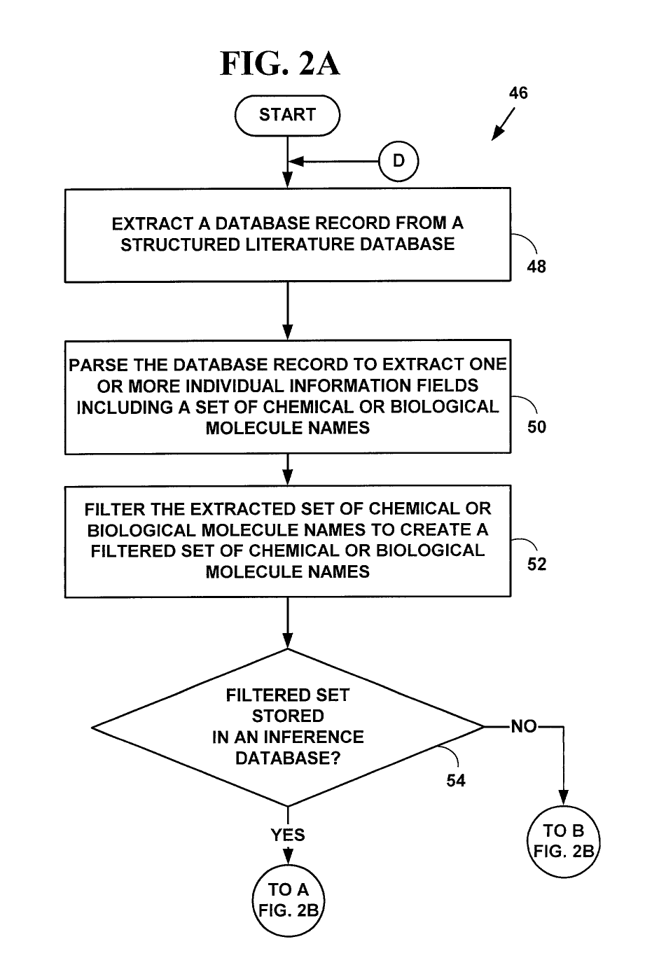

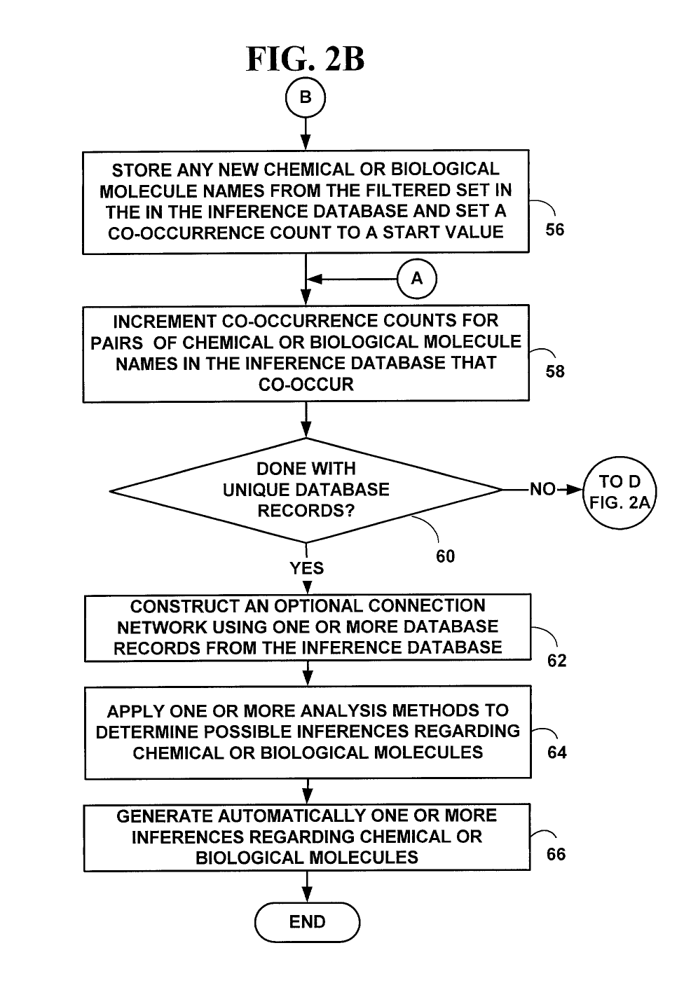

FIGS. 2A and 2B are a flow diagram illustrating a Method 46 for creating inferences automatically. In FIG. 2A at Step 48, a database record is extracted from a structured literature database. At Step 50, the database record is parsed to extract one or more individual information fields including a set (e.g., two or more) of chemical or biological molecule names. The chemical names include, for example, organic and inorganic chemical names for natural or synthetic chemical compounds or chemical molecules. The biological molecule names include, for example, natural (e.g. DNA, RNA, proteins, amino acids, etc.) or synthetic (e.g., bio-engineered) biological compounds or biological molecules. As used herein, “names” may include either textual names, chemical formulae, or other identifiers (e.g., GenBank accession numbers or CAS numbers). Hereinafter these chemical and biological molecule names are referred to as “chemical or biological molecule names” for simplicity.

At Step 52, the extracted set of chemical or biological names is filtered to create a filtered set of chemical or biological molecule names. At Step 54 a test is conducted to determine whether any chemical or biological molecule names in the filtered set have been stored in the inference database. If any of the chemical or biological molecule names in the filtered set have not been stored in an inference database, at Step 56 any new chemical or biological molecule names from the filtered set are stored in the inference database. Co-occurrence counts for each newly stored pair of chemical or biological molecule names in the set is initialized to a start value (e.g., one).

If a co-occurring pair of chemical or biological molecule names has already been stored in the inference database, in FIG. 2B at Step 58, a co-occurrence count for that pair of chemical or biological molecule names is incremented in the interference database. As is known in the art, a “co-occurrence” is a simultaneous occurrence of two (or more) terms (i.e., words, phrases, etc.) in a single document or database record. In one embodiment of the present invention, co-occurrence counts are incremented for every pair of chemical or biological molecules that co-occur. In another embodiment of the present invention, co-occurrence counts are incremented only for selected ones of chemical or biological molecules that co-occur based on a pre-determined set of criteria. Thus, Step 58 may include multiple iterations to increment co-occurrence counts for co-occurrences.

At Step 60 a loop is entered to repeat steps 48, 50, 52 for unique database records in the structured literature database. When the unique database records in the structured literature database have been processed, the loop entered at Step 60 terminates. At Step 62 an optional connection network is constructed using one or more database records from the inference database including co-occurrence counts. Preferred embodiments of the present invention may be used without executing Step 62. In such embodiments, Step 64 is executed directly on one or more database records from the inference database. The connection network is inherent in the inference database records.

At Step 64, one or more analysis methods are applied to the connection network or directly to one or more database records from the inference database to determine possible inferences regarding chemical or biological molecules. The possible inferences include inferences that particular physico-chemical interactions regarding chemical or biological molecules are known by experts to occur or thought by experts to occur. As is known in the art, “physico-chemical interactions” are physical contacts and/or chemical reactions between two or more molecules, leading to, or contributing to a biologically significant result. At Step 66, one or more inferences regarding chemical or biological molecule interaction knowledge are automatically (i.e., without further input) generated using results from the one or more analysis methods.

Method 46 is repeated frequently to update the inference database with new information as it appears in indexed scientific literature databases. This continually adds to the body of knowledge available in the inference database.

Method 46 is illustrated with one exemplary embodiment of the present invention used with biological information. However, present invention is not limited to such an exemplary embodiment and other or equivalent embodiments can also be used with Method 46. In addition Method 46 can be used with other than biological information, or with biological information in order to infer expert knowledge regarding relationships other than physico-chemical interactions regarding chemical or biological molecules.

In such an embodiment in FIG. 2A at Step 48, a database record is extracted from a structured literature database. What biologists have collectively determined regarding physico-chemical interactions regarding molecules in cells is collectively known as “knowledge,” and is published in the open scientific literature. This knowledge is, therefore available for automated manipulation by computers. Although many scientific publications are now available in computer-readable (e.g., electronic) form, their textual content is generally not structured in such a way as to facilitate such automated extraction of information from that text (i.e., the computer-readable content is in “flat text” form.)

However, numerous indexing services exist to create databases of basic information regarding scientific publications (such as titles, authors, abstracts, keywords, works cited, etc.). Examples include the National Library of Medicine's “Medline” and its Web interface, “PubMed” (www.ncbi.nlm.nih.gov/PubMed) Biosis' “Biological Abstracts” (www.biosis.org/htmls/products_services/ba.html), the Institute for Scientific Information's “Science Citation Index” (www.isinet.com/products/citationi/citsci.html) and others. Since these database records are structured they can be used for automated analysis.

Additionally, several such indexes include information about the scientific articles they index (so-called “meta-data”). These meta-data, generally assigned by domain-knowledgeable human indexers, constitute an additional resource for automated analysis above and beyond the actual text of a scientific article. An example of such meta-data is an exemplary indexed database record (e.g, from Medline) illustrated in Table 1. However, the present invention is not limited to the meta-data illustrated in Table 1 and other or equivalent meta-data can also be used.

TABLE 1
Copyright © 1998, Medline. All rights reserved.

| | |
|---|---|
| UI | 98232076 |
| AU | Rose L |
| AU | Busa WB |
| TI | Crosstalk between the phosphatidylinositol cycle and MAP |
| | kinase Signaling pathways in Xenopus mesoderm induction. |
| LA | Eng |
| MH | Animal |
| MH | Biological Markers |
| MH | Ca(2+)-Calmodulin Dependent Protein Kinase/*physiology |
| MH | DNA-Binding Proteins/biosynthesis/genetics |
| MH | Embryo, Nonmammalian/physiology |
| MH | Embryonic Induction/*physiology |
| MH | Fibroblast Growth Factor, Basic/*pharmacology |
| MH | Gene Expression Regulation, Developmental/drug effects |
| MH | Mesoderm/drug effects/*physiology |
| MH | Microinjections |
| MH | Phosphatidylinositols/*physiology |
| MH | Receptors, Serotonin/drug effects/genetics |
| MH | Recombinant Fusion Proteins/physiology |
| MH | Serotonin/pharmacology |
| MH | Signal Transduction/drug effects/*physiology |
| MH | Transcription Factors/biosynthesis/genetics |
| MH | Xenopus laevis/*embryology |
| RN | EC 2.7.10.-(Ca(2+)-Calmodulin Dependent Protein Kinase) |
| RN | 0 (serotonin 1C receptor) |
| RN | 0 (Biological Markers) |
| RN | 0 (Brachyury protein) |
| RN | 0 (DNA-Binding Proteins) |
| RN | 0 (Fibroblast Growth Factor, Basic) |
| RN | 0 (Phosphatidylinositols) |
| RN | 0 (Receptors, Serotonin) |
| RN | 0 (Recombinant Fusion Proteins) |
| RN | 0 (Transcription Factors) |
| RN | 50-67-9 (Serotonin) |
| PT | JOURNAL ARTICLE |
| DA | 19980706 |
| DP | 1998 Apr |
| IS | 0012-1592 |
| TA | Dev Growth Differ |
| PG | 231-41 |
| SB | M |
| CY | JAPAN |
| IP | 2 |
| VI | 40 |
| JC | E7Y |
| AA | Author |
| EM | 199809 |
| AB | Recent studies have established a role for the phosphoinositide |
| | (PI) cycle in the early patterning of Xenopus mesoderm. In |
| | explants, stimulation of this pathway in the absence of growth |
| | factors does not induce mesoderm, but when accompanied by |
| | growth factor treatment, simultaneous PI cycle stimulation |
| | results in profound morphological and molecular changes in the |
| | mesoderm induced by the growth factor. This suggests the |
| | possibility that the PI cycle exerts its influence via crosstalk, |
| | by modulating some primary mesoderm-inducing pathway. |
| | Given recent identification of mitogen-activated protein |
| | kinase (MAPK) as an intracellular mediator of some mesoderm- |
| | inducing signals, the present study explores MAPK as a |
| | potential site of PI cycle mediated crosstalk. We report |
| | that MAPK activity, like PI cycle activity, increases in |
| | intact embryos during mesoderm induction. Phosphoinositide |
| | cycle stimulation during treatment of explants with basic |
| | fibroblast growth factor (bFGF) synergistically increases |
| | late-phase MAPK activity and potentiates bFGF-induced |
| | expression of Xbra, a MAPK-dependent mesodermal marker. |
| AD | Department of Biology, The Johns Hopkins University, |
| | Baltimore, MD 21218, USA. |
| PMID | 0009572365 |
| EDAT | 1998/05/08 02:03 |
| MHDA | 1998/05/08 02:03 |
| SO | Dev Growth Differ 1998 Apr; 40(2):231-41 |

In Table 1, each field of information is placed on a new line beginning with a two- to four-letter capitalized abbreviation followed by a hyphen. For example, the second and third fields in this record (beginning with “AU -”) identify the individual authors of the published article this record refers to. Such author names are extracted directly from the published article. In contrast, the information included in the record's RN fields indicates various chemical or biological molecules this article is concerned with. This meta-data is typically supplied by human indexers (e.g., in the case of Medline records, indexers at the National Library of Medicine, who study each article and assign RN values by selecting from a controlled vocabulary of chemical or biological molecule names).

At Step 50, the database record is parsed to extract one or more individual information fields including a set (two or more) chemical or biological molecule names. For example, using the information from Table 1, Step 50 would extract the multiple RN fields from the Medline record indicating various chemical or biological molecules used in the experiments described in the published article such as “RN EC 2.7.10.- (Ca(2+)- Calmodulin Dependent Protein Kinase),” etc.

At Step 52, the extracted set of chemical or biological names is filtered to create a filtered set of chemical or biological molecule names. In one embodiment of the present invention, chemical or biological molecule names in included the set of names extracted at Step 50 are filtered against a “stop-list” of trivial terms to be ignored. In the exemplary record from Table 1, the generic term “Biological Markers” is an exemplary trivial term to be ignored, as it represents a general concept rather than a specific chemical or biological molecule name.

At Step 52, the extracted set of chemical or biological names is filtered to create a filtered set of chemical or biological molecule names. At Step 54 a test is conducted to determine whether any chemical or biological molecule names in the filtered set have been stored in the inference database. If any of the chemical or biological molecule names in the filtered set have not been stored in an inference database, at Step 56 any new chemical or biological molecule names from the filtered set are stored in the inference database. Co-occurrence counts for each newly stored pair of chemical or biological molecule names in the set is initialized to a start value (e.g., one).

In one embodiment of the present invention, if, for an individual database record, two or more chemical or biological molecule names survive the filtering at Step 52, a co-occurrence of these names is recorded in an inference database record or in other computer-readable format.

If a co-occurring pair of chemical or biological molecule names has already been stored in the inference database, in FIG. 2B at Step 58, a co-occurrence count for that pair of chemical or biological molecule names is incremented in the interference database. Thus, Step 58 may include multiple iterations to increment co-occurrence counts for co-occurrences.

At Step 60 a loop is entered to repeat steps 48, 50, 52 for unique database records in the structured literature database. When the unique database records in the structured literature database have been processed, the loop entered at Step 60 terminates.

At Step 62, a connection network is optionally constructed using one or more database records from the inference database including co-occurrence counts. However, Step 64 can be executed directly without explicitly creating a connection network. A connection network is often created as to provide a visual aid to a researcher.

In one embodiment of the present invention, the connection network can be represented with an undirected-graph. As is known in the art, an undirected “graph” is a data structure comprising two or more nodes and one or more edges, which connect pairs of nodes. If any two nodes in a graph can be connected by a path along edges, the graph is said to be “connected.”

In another embodiment of the present invention, the connection network is represented with a directed graph. As is known in the art, a “directed graph” is a graph whose edges have a direction. An edge or arc in a directed graph not only relates two nodes in a graph, but it also specifies a predecessor-successor relationship. A “directed path” through a directed graph is a sequence of nodes, (n₁, n₂, . . . nₖ), such that there is a directed edge from n₁ to nᵢ₊₁ for all appropriate i.

It will be appreciated by those skilled in the art that the connection network or “graph” referred to here is inherent in the inference database. Constructing the connection network at Step 62 denotes storing the connection network in computer memory, on a display device, etc. as needed for automatic manipulation, automatic analysis, human interaction, etc. Constructing a connection network may also increase processing speed during subsequent analysis steps.

In one embodiment of the present invention, the connection network includes two or more nodes for one or more chemical or biological molecule names and one or more arcs connecting the two or more nodes. The one or more arcs represent co-occurrences regarding two chemical or biological molecules. An arc may have assigned to it any of several attributes that may facilitate subsequent analysis. In one specific embodiment of the present invention an arc has assigned to it a co-occurrence count (i.e., the number of times this co-occurrence was encountered in the analysis of the indexed scientific literature database). However the present invention is not limited to such a specific embodiment and other attributes can also be assigned to the arcs.

At Step 64, one or more analysis methods are applied to the connection network to determine possible inferences regarding chemical or biological molecules. Any of a wide variety of analysis methods, including statistical analysis are performed on the connection in order to distinguish those arcs which are highly likely to reflect physico-chemical interactions regarding chemical or biological molecules from those arcs which represent trivial associations.

At Step 66, one or more inferences regarding chemical or biological molecules are automatically (i.e., without further input) generated using the results of the analysis methods. These inferences may or may not later be reviewed by human experts and manually refined.

The present invention analyzes database indexes, such as Medline, which directly or indirectly indicate what chemical or biological molecules scientific articles are concerned with. If a scientific article reports evidence of the physico-chemical interaction of two or more chemical or biological molecules, then molecules will be referenced in the index's record for that article (e.g., in the case of Medline, each such molecule would be named in an RN field of the record for that article). Thus, a tabulation of co-occurrences of chemical or biological molecules within individual index records will include a more-or-less complete listing of known physico-chemical interactions regarding the chemical or biological molecules based on information in the indexed database.

Additionally, such a tabulation would include co-occurrences which do not reflect known physico-chemical interactions within cells, but rather reflect trivial relationships. For example, a scientific report might mention the protein, MAP kinase, and the simple salt, sodium chloride (“NaCl”) in two distinct contexts without reporting a physico-chemical interaction between these molecules. Yet an indexer might nonetheless assign both of these chemical names to RN fields in this article's record. In this case, the co-occurrence of “MAP kinase” and “NaCl” within the Medline record would not reflect a physico-chemical interaction. Thus, the connection network of associations generated with Method 46 from a tabulation of co-occurrences will include known physico-chemical interactions that are biologically relevant as well as a (probably large) number of trivial associations between molecules that are biologically irrelevant.

In one embodiment of the present invention, the one or more inferences are stored in the inference database 24, 26. In addition, subsequent analysis methods are applied to the inferences to reject trivial inferences. Such subsequent analysis methods may include, but are not limited to: (1) Assigning probabilities to arcs based simply on co-occurrence counts; (2) Assigning probabilities based on analysis of the temporal pattern of an association's co-occurrence count as a function of another variable (e.g., year of publication). For example, an association between two chemicals or biological molecules based on co-occurrences observed in ten articles published in 1996, with no additional co-occurrences observed in subsequent years, might well be a trivial association, whereas an association based on ten co-occurrences per year for the years 1996 through the current year might be judged likely to reflect a true physico-chemical interaction; (3) “Mutual information” analysis. For example a link between A and B may be most likely to reflect a known physico-chemical interaction if, in the indexed scientific literature database, both the presence of A's name in records has a probabilistic impact on the presence of B's name and the absence of A's name has a probabilistic impact on the absence of B's name; and (4) Citation analysis. As is known in the art, Citation analysis is a method for analyzing how related groups of technical documents are by analyzing the patterns of documents they reference or cite. It may be the case that articles in which a legitimate co-occurrence occurs cite each other much more frequently than do articles in which a trivial co-occurrence occurs.

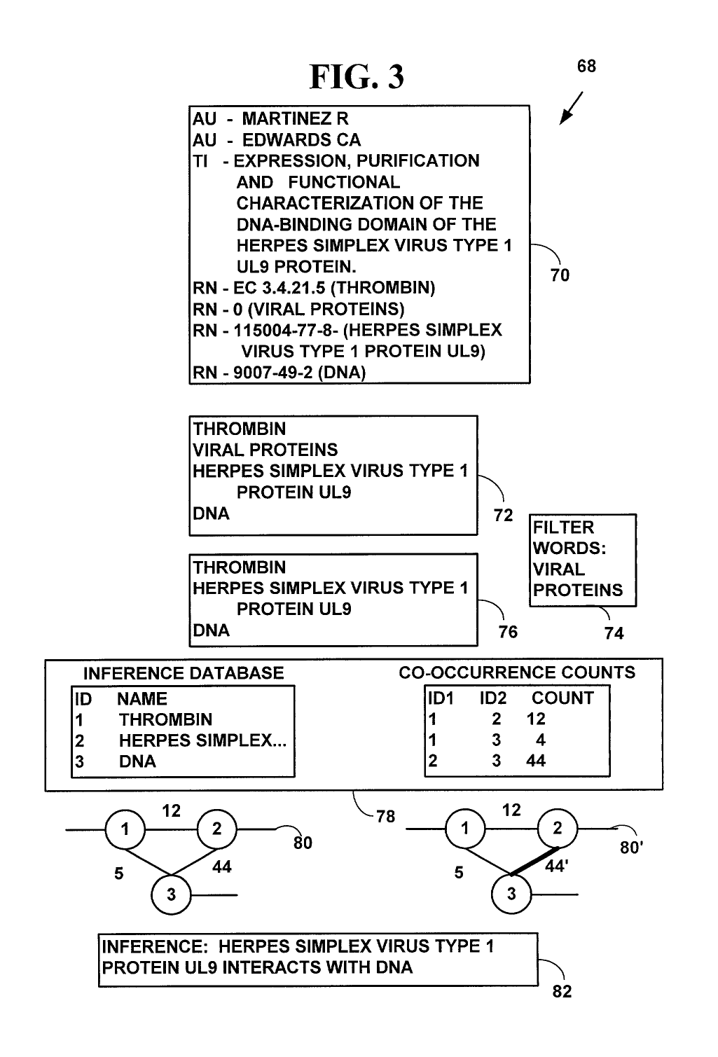

FIG. 3 is a block diagram 68 visually illustrating selected steps of Method 46. In FIG. 2A at Step 48, an exemplary database record 70 (FIG. 3) is extracted from a structured literature database such as MedLine. At Step 50, the database record 70 is parsed to extract one or more individual information fields 72 (FIG. 3) including a set (two or more) chemical or biological molecule names. In this example, four fields beginning with RN from Box 70 are extracted as is illustrated by Box 72. At Step 52, the extracted set of chemical or biological names is filtered to create a filtered set of chemical or biological molecule names using a “stop-list” of chemical or biological molecule names. Box 74 of FIG. 3 illustrates one exemplary word, “Viral Proteins” to filter from the list of chemical or biological molecule names obtained from database record 70. At Step 54 a test is conducted to determine whether any of the chemical or biological molecule names from the filtered set of chemical and biological molecule names has been stored in an inference database 24, 26 (FIG. 1). If any of the chemical or biological molecule names from the filtered set of chemical and biological molecule names have not been stored in an inference database 24, 26, at Step 56 any new chemical and biological names are stored in the inference database as is illustrated with the exemplary database records in Box 76 of FIG. 3.

If a co-occurrence pair of chemical or biological molecules has already been stored in the inference database, in FIG. 2B at Step 58, co-occurrence counts for the chemical or biological molecule names are incremented in the interference database as is illustrated with Box 78 of FIG. 3. For example, Box 78 illustrates a co-occurrence count of 12 for Thrombin and the Herpes Simplex Virus Type 1 Protein UL9, a co-occurrence count of 5 for Thrombin and DNA, and a co-occurrence count of 44 for the Herpes Simplex Virus Type 1 Protein UL9 and DNA.

At Step 60 a loop is entered to repeat steps 48, 50, 52 for unique database records in the structured literature database. When the unique database records in the structured literature database have been processed, the loop entered at Step 60 terminates. In this example, loop 60 would have been executed at least 44 times for at least 44 unique records in the structured literature database as is indicated by the co-occurrence count of 44 in Box 78.

At Step 62 an optional connection network 80 is constructed using one or more database records from the inference database including co-occurrence counts. The exemplary connection network 80 includes three nodes and three arcs connecting the three nodes with assigned co-occurrence counts as illustrated. In this example, the nodes represent the chemical or biological molecule names (i.e., IDs 1-3) from Box 76. The arcs include co-occurrences counts illustrated in Box 78.

At Step 64, one or more analysis methods are applied to the connection network 80 or directly to database records in the inference database to determine any physico-chemical inferences between chemical or biological molecules. For example, when statistical methods are applied to the connection network 80, it is determined that there may be a strong inference between the Herpes Simplex Virus Type 1 Protein UL9 and DNA as is indicated by the highlighted co-occurrence count of 44′ in connection network 80′.

At Step 66, one or more inferences 82 regarding chemical or biological molecules are automatically generated using the results from the one or more analysis methods. For example, an inference 84 is generated that concludes “The Herpes Simplex Virus Type 1 Protein UL9 interacts with DNA” based on the large co-occurrence count of 44.

Method 46 allows inferences, based on co-occurrences of chemical or biological names in indexed literature databases, regarding physico-chemical interactions between chemical or biological molecules to be automatically generated. Method 46 is described for co-occurrences. However, the Method 46 can also be used with other informational fields from indexed literature databases and with other attributes in the connection network and is not limited to determining inferences with co-occurrence counts.

Removing Trivial Inferences Automatically

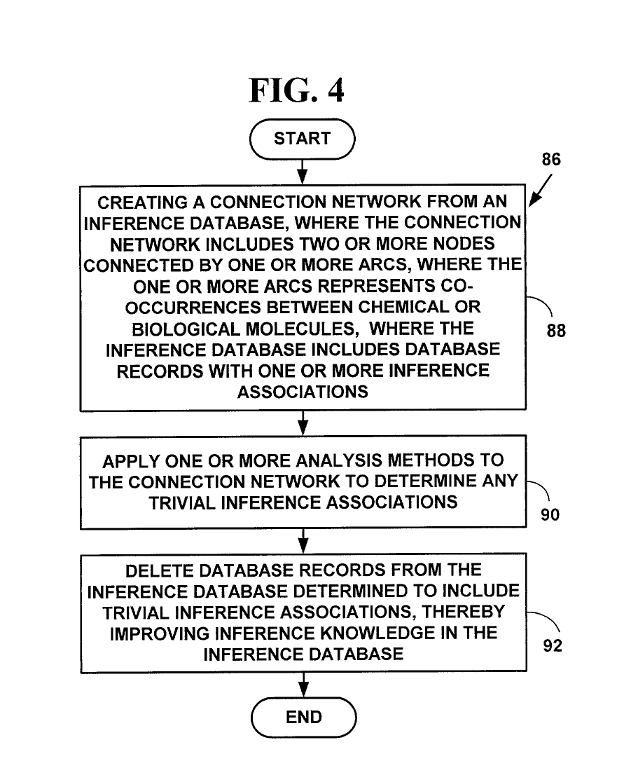

FIG. 4 is a flow diagram illustrating a Method 86 for automatically checking generated inferences. At Step 88, connection network is created from an inference database including inference knowledge. The connection network includes two or more nodes representing one or more chemical or biological molecule names and one or more arcs connecting the two or more nodes. The one or more arcs represent co-occurrences between chemical or biological molecules. The inference database includes one or more inference database records including inference association information. The connection network can be explicitly created, or implicitly created from database records in the inference database as is discussed above. At Step 90, one or more analysis methods are applied to the connection network to determine any trivial inference associations. The one or more analysis methods can be applied to the connection network or to database records from the inference database as was discussed above. At Step 92, database records determined to include trivial inference associations are deleted automatically from the inference database, thereby improving the inference knowledge stored in the inference database.

Method 86 is illustrated with one specific exemplary embodiment of the present invention used with biological information. However, present invention is not limited to such an exemplary embodiment and other or equivalent embodiments can also be used with Method 86. In addition Method 86 can be used with other than biological information, or to infer other than physico-chemical interactions.

At Step 88, connection network 80 (FIG. 3) is created from an inference database 24,26 (FIG. 1) including inference knowledge. At Step 90, one or more analysis methods are applied to the connection network to determine any trivial inference associations. In one embodiment of the present invention, one or more of the subsequent analysis methods described above for Method 46 are applied at Step 90. However, other analysis methods could also be used and the present invention is not limited to the subsequent analysis methods described above. For example, the data in Box 78 reflects co-occurrences between Thrombin and DNA with a co-occurrence count of 5. However, this co-occurrence does not really reflect a physico-chemical interaction, but instead reflects a trivial relationship between these two biological molecule names. Such trivial inferences are removed from the inference database 24, 26. In the example of FIG. 3, the inference between nodes 1 and 3 is also judged to be trivial due to its low co-occurrence count.

At Step 92, database records determined to include trivial inferences with trivial co-occurrence counts are deleted automatically from the inference database, thereby improving the inference knowledge stored in the inference database. For example, the co-occurrence count of 5 in Box 78 for the trivial association between Thrombin (node 1) and DNA (node 3) would be removed, thereby improving the inference knowledge stored in the inference database. This deletion would also remove the arc with the co-occurrence count of 5 in the connection network 80 between nodes one and three if the connection network was stored in the inference database 24, 26.

The methods and system described herein enable automated creation of an inference database of public knowledge regarding physico-chemical interactions between biological and chemical molecules. Such an inference database may be used to further facilitate a user's understanding of biological functions, such as cell functions. Specifically, the resulting computer-readable knowledge may enable automated analysis and interpretation of high-volume biological data including, but not limited to high-content and high-throughput screening systems (e.g., cell screening systems). More specifically, the present invention may help drug discovery scientists select better targets for pharmaceutical intervention in the hope of curing diseases.

In view of the wide variety of embodiments to which the principles of the present invention can be applied, it should be understood that the illustrated embodiments are exemplary only. The illustrated embodiments should not be taken as limiting the scope of the present invention.

For example, the steps of the flow diagrams may be taken in sequences other than those described, and more or fewer elements may be used in the block diagrams. While various elements of the preferred embodiments have been described as being implemented in software, in other embodiments in hardware or firmware implementations may alternatively be used, and vice-versa.

The claims should not be read as limited to the described order or elements unless stated to that effect. Therefore, all embodiments that come within the scope and spirit of the following claims and equivalents thereto are claimed as the invention.

I claim:

1. A method for creating automated inferences, comprising:
(a) extracting a database record from a structured literature database;
(b) parsing the database record to extract one or more individual information fields, wherein the one or more individual information fields include a set of chemical or biological molecule names;
(c) filtering the extracted set of chemical or biological molecule names to create a filtered set of chemical or biological molecules names;
(d) determining whether a chemical or biological molecule name from the filtered set has been stored in an inference database,
and if not,
storing the chemical or biological name in the inference database, and setting a co-occurrence count to a starting value for each pair of names including the chemical or biological name and other names from the filtered set that the chemical or biological name co-occurs with;
and if so,
incrementing co-occurrence counts for each pair of chemical or biological names including the chemical or biological name;
(e) repeating steps (a)-(d) for unique database records in the structured literature database;
(f) optionally constructing a connection network using a plurality of database records from the inference database including co-occurrence counts;
(g) applying one or more analysis methods directly to database records in the inference database or to the optional connection network to determine possible inferences of physico-chemical relationships between chemical or biological molecules; and
(h) generating automatically a plurality of inferences regarding physico-chemical relationships between chemical or biological molecules using the results from the one or more analysis methods.

2. The method of claim 1 further comprising a computer readable medium having stored therein instructions for causing a processor to execute the steps of method.

3. The method of claim 1 wherein extracting step includes extracting a plurality of database records with a pre-determined database record structure.

4. The method of claim 3 wherein the extracting step includes extracting a database record with a pre-determined structure from Medline, PubMed, Biological Abstracts or Science Citation Index databases.

5. The method of claim 1 wherein the parsing step includes parsing the database record to extract a record information field indicating two or more chemical or biological molecule names used in an experiment recorded in the database record.

6. The method of claim 1 wherein the filtering step includes filtering the chemical or biological molecule names against a list of trivial chemical or biological molecule names to be ignored.

7. The method of claim 1 wherein the step of optionally constructing a connection network includes constructing a connection network including a plurality of nodes representing a plurality of chemical or biological molecules names and a plurality of arcs connecting the plurality of nodes, wherein the plurality of arcs represent co-occurrences between chemical or biological molecules.

8. The method of claim 1 wherein the applying step includes applying statistical analysis methods to co-occurrence counts stored in the inference database.

9. The method of claim 1 wherein the generating step includes generating automatically inferences for physico-chemical interactions between chemical or biological molecules using the co-occurrence counts stored in the inference database.

10. The method of claim 9 wherein the physico-chemical interactions between chemical or biological molecules include physico-chemical interactions for chemical or biological molecules for cells.

11. The method of the claim 1 wherein the chemical or biological molecule names include natural or synthetic chemical compound or chemical molecule names or natural or synthetic biological molecule or biological compound names.

12. The method of claim 1 further comprising storing the plurality of inferences in the inference database.

13. The method of claim 1 further comprising applying subsequent analysis methods to the connection network to reject trivial inference associations.

14. The method of claim 13 wherein the subsequent analysis methods include assigning derived numerical values to arcs in the connection network based on co-occurrence counts, assigning derived numerical values to arcs in the connection network based on analysis of a temporal pattern of an inference association's co-occurrence count as a function of another variable, conducting a mutual information analysis, or conducting a Citation analysis.

15. The method of claim 1 wherein the step incrementing step includes incrementing a plurality of co-occurrence counts for pairs of chemical or biological molecule names in the filtered set.

16. A method for checking automatically created inferences, comprising creating a connection network from an inference database including inference knowledge, wherein the connection network includes a plurality of nodes representing a plurality of chemical or biological molecules names and a plurality of arcs connecting the plurality of nodes, wherein the plurality of arcs represent co-occurrences counts between chemical or biological molecules and wherein the inference database includes a plurality of inference database records including inference association information;
applying one or more analysis methods to the connection network to determine any trivial inference associations; and
deleting automatically database records determined to include trivial inference associations from the inference database, thereby improving the inference knowledge stored in the inference database.

17. The method of claim 16 further comprising a computer readable medium having stored therein instructions for causing a processor to execute the steps of method.

18. The method of claim 16 wherein the applying step includes assigning derived numerical values to arcs in the connection network based on co-occurrence counts, assigning derived numerical values to arcs in the connection network based on analysis of a temporal pattern of an inference association's co-occurrence count as a function of another variable, conducting a mutual information analysis, or conducting a Citation analysis.

19. The method of claim 16 wherein the inference association information includes physico-chemical interactions for chemical or biological molecules for cells.

20. The method of claiml6 wherein the connection network includes a directed graph or an un-directed graph.

21. An automated inference system, comprising, in combination:
an automated inference creator for extracting a database record from a structured literature database, parsing the database record to extract one or more individual information fields, wherein the one or more individual information fields include a set of chemical or biological molecule names, filtering the extracted set of chemical or biological molecule names to create a filtered set of chemical or biological molecules names, determining whether a chemical or biological molecule name from the filtered set has been stored in an inference database, and if not, storing the chemical or biological name in the inference database, and setting a co-occurrence count to a starting value for each pair of names including the chemical or biological name and another name from the filtered set that the chemical or biological name co-occurs with, and if so, incrementing co-occurrence counts for each pair of chemical or biological names including the chemical or biological name, optionally constructing a connection network using a plurality of database records from the inference database including co-occurrence counts, applying one or more analysis methods directly to database records in the inference database or to the optional connection network to determine possible inferences of physico-chemical relationships between chemical or biological molecules, and generating automatically a plurality of inferences regarding physico-chemical relationships between chemical or biological molecules using the results from the one or more analysis methods;
an automated inference checker for creating a connection network from an inference database including inference knowledge, wherein the connection network includes a plurality of nodes representing a plurality of chemical or biological molecules names and a plurality of arcs connecting the plurality of nodes, wherein the plurality of arcs represent co-occurrences counts between chemical or biological molecules and wherein the inference database includes a plurality of inference database records including inference association information, applying one or more analysis methods to the connection network to determine any trivial inference associations, deleting automatically database records determined to include trivial inference associations from the inference database, thereby improving the inference knowledge stored in the inference database;
one or more connection networks for creating inferences, wherein a connection network includes a plurality of nodes representing a plurality of chemical or biological molecules names and a plurality of arcs connecting the plurality of nodes, wherein the plurality of arcs represent co-occurrences between chemical or biological molecule names in indexed scientific literature database records; and
an inference database for storing co-occurrence information, generating automatically inferences regarding known physico-chemical interactions regarding chemical or biological molecules using the co-occurrence counts stored in the inference database.

22. The system of claim 21 wherein the physico-chemical interactions regarding chemical or biological molecules include physico-chemical interactions for chemical or biological molecules for cells.

23. The system of claim 21 wherein the connection network includes an un-directed graph or a directed graph.
